(19) United States
(12) Patent Application Publication
(10) Pub. No.: US 2025/0282411 A1
(43) Pub. Date: Sep. 11, 2025

(54) SPINDLE DRIVE FOR A VEHICLE STEERING GEAR AND VEHICLE STEERING GEAR

(71) Applicant: ZF CV Systems Global GmbH, Bern (CH)

(72) Inventors: Bastian Eßer, Wegberg (DE); Florian Zihm, Essen (DE); Guilherme Fernandes da Silva, Essen (DE)

(21) Appl. No.: 19/070,657

(22) Filed: Mar. 5, 2025

(30) Foreign Application Priority Data
Mar. 6, 2024 (DE) 102024106425.0

(51) Int. Cl. B62D 3/06

(52) U.S. Cl. CPC B62D 3/06

(57) ABSTRACT

A spindle drive for a vehicle steering gear, including a spindle having an external thread and a spindle nut having an internal thread being guided on the external thread. One of the spindle and spindle nut is rotatable and produces a corresponding translational movement of the other. The other of the spindle and spindle nut is guided via a plain bearing along the axis of rotation relative to a fixed structural part. The plain bearing is formed between sliding surfaces of a first and second bearing part, the first being provided on the other of the spindle and spindle nut and the second being provided on the fixed structural part. One of the first and second bearing parts is designed as an elevation, the other being designed as a recess. The recess surrounds the elevation on both sides in a rotational direction.

### CROSS REFERENCE TO RELATED APPLICATIONS

This application claims benefit to German Patent Application No. DE 10 2024 106 425.0, filed on Mar. 6, 2024, which is hereby incorporated by reference herein.

### FIELD

The invention relates to a spindle drive for a vehicle steering gear and to a vehicle steering gear having at least one spindle drive.

### BACKGROUND

Spindle drives are used in very different fields in order to convert a rotational movement into a translational movement, and vice versa. Generally, in a spindle drive, a spindle nut having an internal thread is guided on an external thread of a spindle, wherein the conversion between the rotational movement and the translational movement is carried out by the cooperation of the internal thread and external thread.

A spindle drive for a height adjustment of a vehicle body is disclosed in WO 2018/014902 A1. In this spindle drive, a spindle nut is guided by an internal thread on an external thread of a spindle, wherein the spindle drive is designed specifically as a ball spindle drive, by the internal thread and external thread being coupled together via interposed rolling elements in the form of balls. The spindle nut is rotatably mounted about an axis of rotation via axial bearings in a housing, wherein a rotation of the spindle nut is converted into a corresponding translational movement of the spindle along the axis of rotation, by the cooperation of the external thread and internal thread. The spindle is axially displaceably guided in the housing, wherein this guidance is undertaken via plain bearings, which are configured in each case between two respective sliding surfaces which face one another. In each of the plain bearings, the one sliding surface is designed in each case on a first bearing part, which is formed in each case by one respective tube portion of the housing, while the other sliding surface is defined in each case on a second bearing part, which is formed in each case by a plain bearing ring which is connected fixedly in terms of rotation to the spindle.

### SUMMARY

In an embodiment, the present disclosure provides a spindle drive for a vehicle steering gear, comprising a spindle having an external thread and a spindle nut having an internal thread being guided on the external thread of the spindle. One of the spindle and the spindle nut is rotatable about an axis of rotation and produces, during rotation, by cooperation of the external thread and internal thread, a corresponding translational movement of the other of the spindle and the spindle nut. The other of the spindle and the spindle nut is axially displaceably guided via a plain bearing along the axis of rotation relative to a fixed structural part. The plain bearing is formed between sliding surfaces of a first and second bearing part, the first bearing part being provided on the other of the spindle and the spindle nut and the second bearing part being provided on the fixed structural part. One of the first and second bearing parts is designed in cross section as an elevation which protrudes transversely to the axis of rotation into the other of the first and second bearing parts, the other of the first and second bearing parts being designed in cross section as a recess. The recess surrounds the elevation on both sides in cross section in a rotational direction about the axis of rotation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a sectional view of a vehicle steering gear in a region of a spindle drive according to an embodiment of the present disclosure;

FIG. 2 shows a detailed view of the spindle drive according to the present disclosure of FIG. 1;

FIG. 3 shows a sectional view of a vehicle steering gear in the region of a spindle drive according to an embodiment of the present disclosure;

FIG. 4 shows a detailed view of the spindle drive according to the present disclosure of FIG. 3; and

FIG. 5 shows a sectional view of a vehicle steering gear in the region of a spindle drive according to an embodiment of the present disclosure.

### DETAILED DESCRIPTION

In an embodiment, the present disclosure provides a spindle drive in which a reliable function is implemented with a design which is as compact as possible.

According to the present disclosure, a spindle drive comprises a spindle having an external thread, a spindle nut having an internal thread being guided thereon. One component of the two components, namely the spindle and spindle nut, can be rotated about an axis of rotation and produces, during rotation, by the cooperation of the external thread and internal thread, a corresponding translational movement of the other component, which is axially displaceably guided via a plain bearing along the axis of rotation relative to a fixed structural part. The plain bearing is formed between sliding surfaces of two bearing parts, a first bearing part thereof being provided on the part of the other component and a second bearing part thereof being provided on the part of the fixed structural part.

Thus a spindle and a spindle nut, which are operatively connected together via threads, are provided in the spindle drive according to the present disclosure. The spindle nut is provided with an internal thread, the spindle nut running thereby on an external thread of the spindle. The one component of the components, namely the spindle nut and spindle, i.e. either the spindle nut or the spindle, can be rotated about an axis of rotation, while the other component, i.e. the spindle or the spindle nut, is displaceable in a translational manner along the axis of rotation. The rotation of the one component is converted into a corresponding translational movement of the other component along the axis of rotation by the cooperation of the internal thread and external thread, wherein one respective rotational direction of the one component also defines the respective axial direction of the movement, due to the thread pitch directions. Within the meaning of the present disclosure, “axial” is understood to mean an orientation along the axis of rotation, about which the one component of the two components, namely the spindle and spindle nut, is rotatable.

The cooperation of the internal thread and external thread can be implemented by an engagement of the threads, wherein the spindle drive according to the present disclosure, however, particularly preferably has rolling elements which in each case positively couple together the internal thread and the external thread. Particularly preferably these rolling elements are designed as balls, so that the spindle drive according to the present disclosure is designed as a ball spindle drive.

The translationally movable component is axially guided in terms of its movements on a fixed structural part, wherein this guidance is undertaken via a plain bearing. In particular, the plain bearing bears the translationally movable component alone on the fixed structural part, wherein in the context of the present disclosure, however, at least one further bearing can be provided, which can also be designed as a plain bearing or even implemented as a rolling bearing.

In the spindle drive, the plain bearing is implemented between sliding surfaces, which are designed so as to face one another and via which a sliding can be implemented in the axial direction in order to permit the respective translational displacement of the other component relative to the fixed structural part. The sliding surfaces are designed in each case on bearing parts, wherein, of these bearing parts, a first bearing part is provided on the part of the other component, while a second bearing part is provided on the part of the fixed structural part.

A direct guidance of the other component on the fixed structural part can be implemented via the plain bearing thus formed, to which end the first bearing part is thus arranged rigidly, i.e. fixedly in terms of rotation and axially undisplaceably, on the other component, and the second bearing part is provided rigidly on the fixed structural part. As an alternative thereto, however, an indirect guidance of the other component on the fixed structural part can also be brought about via the plain bearing, by at least one of the bearing parts being provided in each case rigidly on a further structural part which is fastened directly or indirectly to the other component or the fixed structural part. Thus, within the meaning of the present disclosure, the provision of the respective bearing part “on the part of” the other component or the fixed structural part means that the respective bearing part is directly or indirectly fastened rigidly to the other component or to the fixed structural part.

In order to implement the axially displaceable guidance of the other component relative to the fixed structural part over the entire axial movement range of the other component, preferably one of the bearing parts and the associated sliding surface is designed with an axial extent which is sufficient for a permanent guidance in the translational direction.

The fixed structural part, on the part of which the second bearing part is provided, is in particular a structural part which is arranged so as to be rotationally and translationally fixed relative to the other component.

The spindle drive according to the present disclosure is preferably provided for use in a vehicle steering gear, which is in particular a steering gear for a utility vehicle. The spindle drive according to the present disclosure is thus configured, in particular, to convert a rotational drive movement into a translational output movement in the vehicle steering gear.

The present disclosure thus encompasses the technical teaching that, of the two bearing parts, the one bearing part is designed in cross section as an elevation which protrudes transversally to the axis of rotation into the other bearing part, which is designed in cross section as a recess. In addition, the recess surrounds the elevation on both sides in cross section in the rotational direction about the axis of rotation. In other words, the bearing parts which produce the plain bearing are thus designed in cross section as an elevation and as a recess, wherein the elevation engages in the recess transversely to the axis of rotation and is surrounded by the recess on both sides in the rotational direction about the axis of rotation.

Such an embodiment of a spindle drive has the advantage that, in addition to the axially displaceable guidance of the other component on the fixed structural part, a rotational lock of the other component relative to the fixed structural part is additionally implemented via the plain bearing, whereby the other component is prevented from rotation and thus the function of the spindle drive is ensured. This is because in order to convert the rotation of the one component into the corresponding translational movement of the other component, this other component has to be permanently prevented from rotating. Since, according to the present disclosure, the one bearing part of the plain bearing is designed as an elevation which engages transversely in the recess designed by the other bearing part, and is also encompassed by the recess on both sides in the rotational direction about the axis of rotation, a rotation of the one bearing part relative to the other bearing part is positively prevented and thus ultimately the other component is also positively held on the fixed structural part in the rotational direction. By shifting this rotational lock into the region of the plain bearing, this can be implemented in a compact manner.

Within the meaning of the present disclosure, a “cross section” of the respective bearing part is understood to mean a section of the respective bearing part having a cutting plane running transversely to the axis of rotation, i.e. at right-angles to the axis of rotation.

Within the meaning of the present disclosure, the recess is designed in particular in the manner of a depression, i.e. its depth is preferably smaller in comparison with its extent in the rotational direction.

According to an embodiment of the present disclosure, the elevation is designed in cross section with a convex rounded shape, wherein the recess is designed in cross section with a concave rounded shape, preferably in combination therewith. As an alternative, the elevation is designed in cross section with a V-shape, wherein the recess is also designed in cross section with a V-shape, in particular in combination therewith. In both cases this leads to surface contacts between the elevation and the recess in both rotational directions during a rotation of the one bearing part relative to the other bearing part.

Particularly preferably, the elevation is designed symmetrically in cross section and relative to a highest point of its cross section. As an alternative, but in particular additionally, the recess is also preferably designed symmetrically in cross section and relative to a lowest point of its cross section.

According to an embodiment of the present disclosure, the elevation and the recess are designed in cross section as counter-parts to one another. Thus a geometry of the cross section of the elevation is adapted to a geometry of the cross section of the recess, and vice versa. This has the advantage that, as a result, the recess is able to bear against the elevation over a large surface area in both rotational directions.

An embodiment of the present disclosure is that the elevation is provided in its highest region in cross section and/or the recess is provided in its lowest region in cross section with one respective groove-like cutout. This enables the risk to be reduced of a linear contact between the recess and the elevation due to tolerances.

In an embodiment of the present disclosure, the respective sliding surface is configured on a coating which is applied to the respective bearing part. In this case, the respective bearing part is thus provided with a coating which thus also forms the respective sliding surface. By a corresponding choice of the material of the coating, a suitable sliding surface can be configured in a simple manner in the corresponding region via a disordered particle structure.

As an alternative to the aforementioned variant of the present disclosure, the respective sliding surface is configured on an element which is fastened to the respective bearing part. As a result, a suitable sliding surface can also be implemented by a corresponding choice of the material of the separate element. An ordered particle structure for implementing the respective sliding surface is thus formed via the separate element, wherein the separate element is preferably present as a bearing shell. As an alternative, however, the use of a film as a separate element is also conceivable.

According to an embodiment of the present disclosure, the second bearing part is formed by a portion of an internal circumference of the fixed structural part, wherein the portion of the internal circumference protrudes into an interior which is defined by the fixed structural part and in which the spindle nut and the spindle are received. Depending on the specific embodiment, according to the present disclosure the bearing part, which is designed as a recess, or the bearing part, which is designed as an elevation, is configured on the portion of the internal circumference of the fixed structural part. Preferably the portion of the internal circumference extends completely axially over the axial movement range to be implemented, wherein the recess or elevation formed in cross section is also configured completely axially over the portion.

According to an embodiment of the present disclosure, which is implemented as an alternative here, but preferably in addition to the aforementioned possible embodiment, the first bearing part is formed by a portion of an external circumference of a further structural part which is rigidly connected to the other component. Thus either the bearing part, which is designed as an elevation, or the bearing part, which is designed as a recess, is configured on the portion of the external circumference. When combined with the aforementioned possible embodiment, the further structural part is thus also received in particular in the interior of the fixed structural part. Preferably, the further structural part is designed in an at least partially cylindrical manner, wherein the portion is thus configured on a cylindrical part of the further structural part. Particularly preferably, the further structural part is an adjusting element of a vehicle steering gear.

Preferably, in the spindle drive according to the present disclosure, the spindle is rotatable and produces, during its rotation, by the cooperation of the external thread and internal thread a corresponding translational movement of the spindle nut. In the context of the present disclosure, however, a reverse design could also be selected, in which the spindle nut is rotatable and produces, during rotation, a corresponding translational movement of the spindle.

In particular, the spindle drive is designed such that the first bearing part is designed as an elevation and the second bearing part is designed as a recess. Thus in this case the elevation is designed on the part of the other component, while the recess is implemented on the part of the fixed structural part.

In an embodiment of the present disclosure, the fixed structural part is a housing, whereby the axially displaceable guidance of the other component, at the same time with a rotational lock, can be implemented in a reliable manner.

The subject matter of the present disclosure is also a vehicle steering gear, which comprises at least one spindle drive, wherein this at least one spindle drive is designed according to one or more of the above-described variants. The at least one spindle drive is preferably used for converting a rotational drive movement of an actuator into a translational adjusting movement of an adjusting element.

Advantageous embodiments of the present disclosure, which are explained hereinafter, are shown in the drawings.

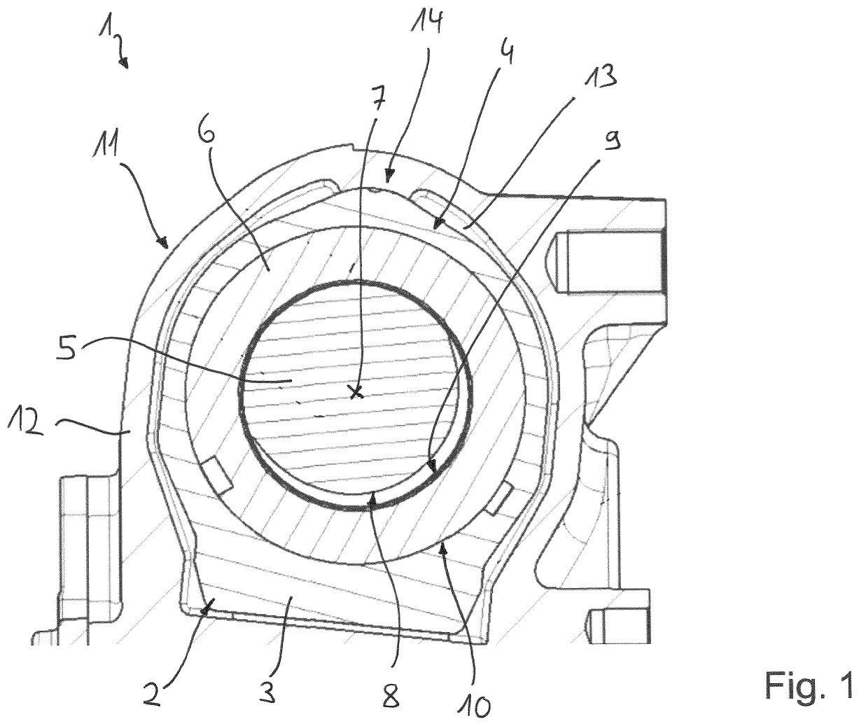

A sectional view of a region of a vehicle steering gear 1, which can specifically be a steering gear of a utility vehicle, is shown in FIG. 1. The vehicle steering gear 1 comprises a structural part 2 which is an adjusting element 3 of the vehicle steering gear 1. The adjusting element 3 can be axially displaced in the vehicle steering gear 1 in order to implement corresponding adjusting movements. To this end, the adjusting element 3 is coupled to a spindle drive 4, which is configured according to an embodiment of the present disclosure and which has a spindle nut 6 in addition to a spindle 5.

The spindle 5 can be set in rotation about an axis of rotation 7 in the vehicle steering gear 1. The spindle 5 is provided with an external thread 8, the spindle nut 6 having an internal thread 9 being guided thereon. The spindle drive 4 is specifically designed as ball spindle drive, by a plurality of rolling elements in the form of balls which in each case produce a positive coupling of the spindle 5 with the spindle nut 6, being placed between the external thread and the internal thread. A rotation of the spindle 5 is converted, via the interposed balls, into an axial movement of the spindle nut 6, which is fixed in the rotational direction, along the axis of rotation 7.

In the present case, the spindle nut 6 is received in the adjusting element 3 in a receiving bore 10, wherein the adjusting element 3 and the spindle nut 6 are fastened rigidly to one another, i.e. are fixedly connected together, both in the rotational direction about the axis of rotation 7 and also axially along the axis of rotation 7. The spindle nut 6 can be pressed for example into the receiving bore 10 of the adjusting element 3.

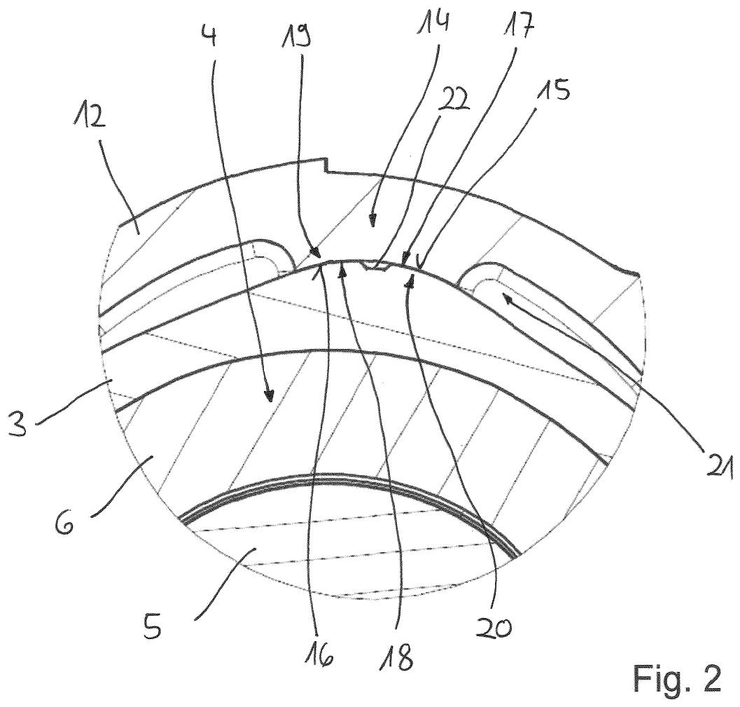

During the joint execution of an axial movement, with a direction of movement dependent on the rotational direction of the spindle 5, the spindle nut 6 and the adjusting element 3 are axially guided jointly on a fixed structural part 11, which can be a housing 12. The adjusting element 3 is received, together with the spindle nut 6 and the spindle 5, in an interior 13 which is defined by the housing 12. The axially displaceable guidance is implemented between the housing 12 and the adjusting element 3 via a plain bearing 14, which is shown in more detail in FIG. 2.

As can be identified in FIG. 2, the plain bearing 14 is produced between sliding surfaces 15 and 16 which are configured on coatings which are applied to bearing parts 17 and 18 of the plain bearing 14. The bearing part 17 is designed in cross section as an elevation 19, with which the adjusting element 3 is provided on an external circumference of a cylindrical portion. This elevation 19 provides the cylindrical portion of the adjusting element 3 with a cam-like design in this region, wherein the elevation 19 protrudes transversely to the axis of rotation 7 in the direction of a recess 20, the bearing part 18 being designed as such on the part of the housing 12 on a portion 21 of an internal circumference of the housing 12 protruding into the interior 13.

Due to the shapes of the cross sections of the two bearing parts 17 and 18, firstly the axial guidance of the adjusting element 3 is made possible, and thus also of the spindle nut 6 on the housing 12, by the sliding surfaces 15 and 16 sliding against one another. However, on the plain bearing 14 a rotational lock of the adjusting element 3 and the spindle nut 6 is also implemented relative to the housing 12, by the bearing part 18, which is designed as a recess 20, surrounding the bearing part 17, which is designed as an elevation 19, on both sides in the rotational direction of the adjusting element 3 and the spindle nut 6 about the axis of rotation 7. As a result, the elevation 19 and the recess 20, in cooperation, positively prevent a relative rotation of the adjusting element 3 and thus also of the spindle nut 6 relative to the housing 12 about the axis of rotation 7.

As can be identified in particular in FIG. 2, the elevation 19 and the recess 20 are designed in cross section as counter-parts to one another, wherein the elevation 19 is configured with a specifically convex rounded shape, while the recess 20 is designed with a concave rounded shape as a counter-part thereto. In addition, a groove-like cutout 22 is incorporated in the elevation 19 in its highest region in cross section, the formation of a surface contact between the sliding surfaces 15 and 16 being promoted thereby.

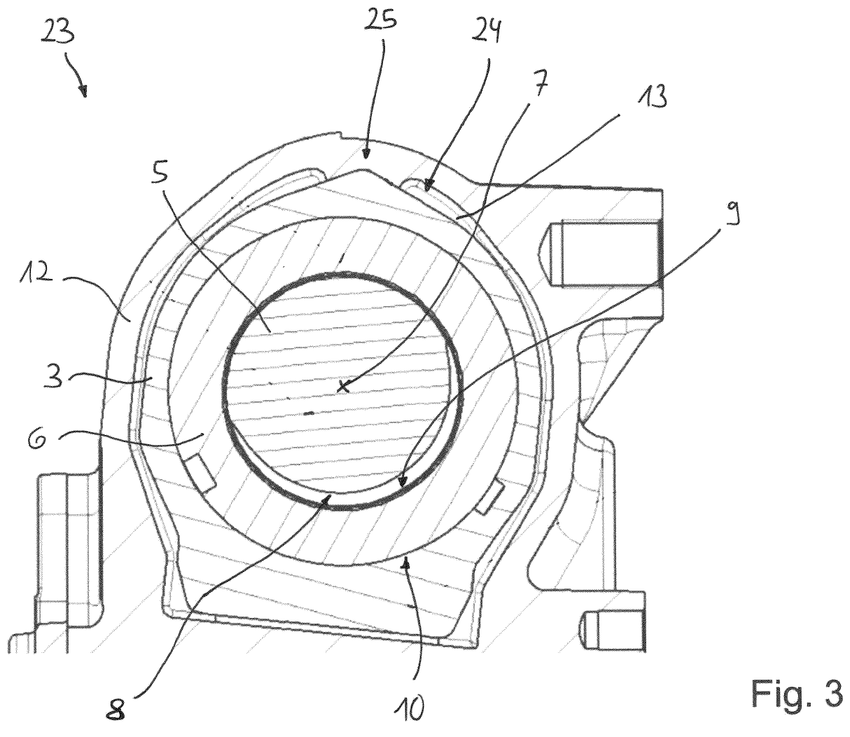

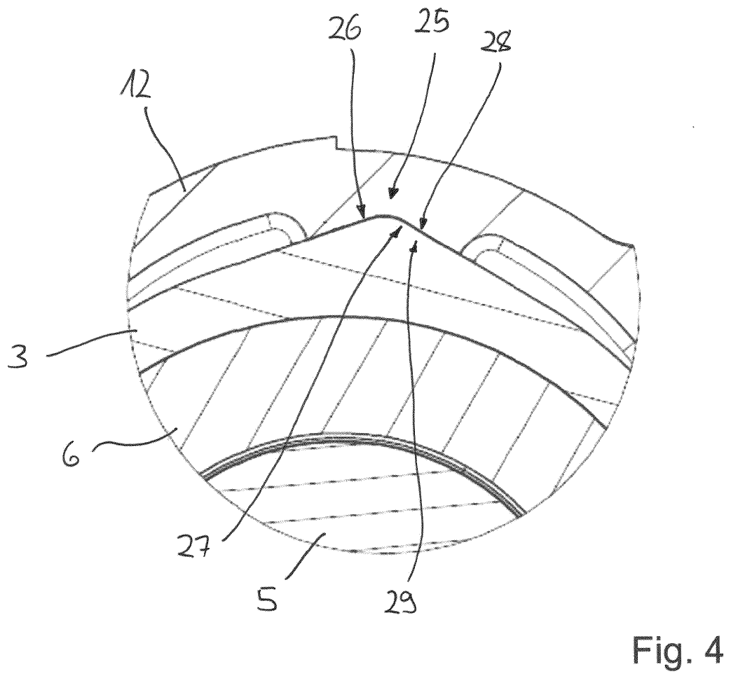

Moreover, FIG. 3 shows a sectional view of a vehicle steering gear 23 which has a spindle drive 24 according to an embodiment of the present disclosure. This vehicle steering gear 23 and also the spindle drive 24 in each case correspond substantially to the above variant according to FIGS. 1 and 2, wherein, in contrast to the embodiment according to FIGS. 1 and 2, a plain bearing 25 is designed differently, the adjusting element 3 and the spindle nut 6 being axially displaceably guided thereby relative to the housing 12. Thus, as can be identified in particular in FIG. 4, an elevation 26 and a recess 27 are thus designed in each case in cross section with a V-shape as counter-parts to one another, the bearing parts 28 and 29 of the plain bearing 25 being designed as such.

In addition, a groove-like cutout is not provided on the part of the elevation 26. Moreover, the embodiment according to FIGS. 3 and 4 corresponds to the variant according to FIGS. 1 and 2, so that reference is made to that described in this regard.

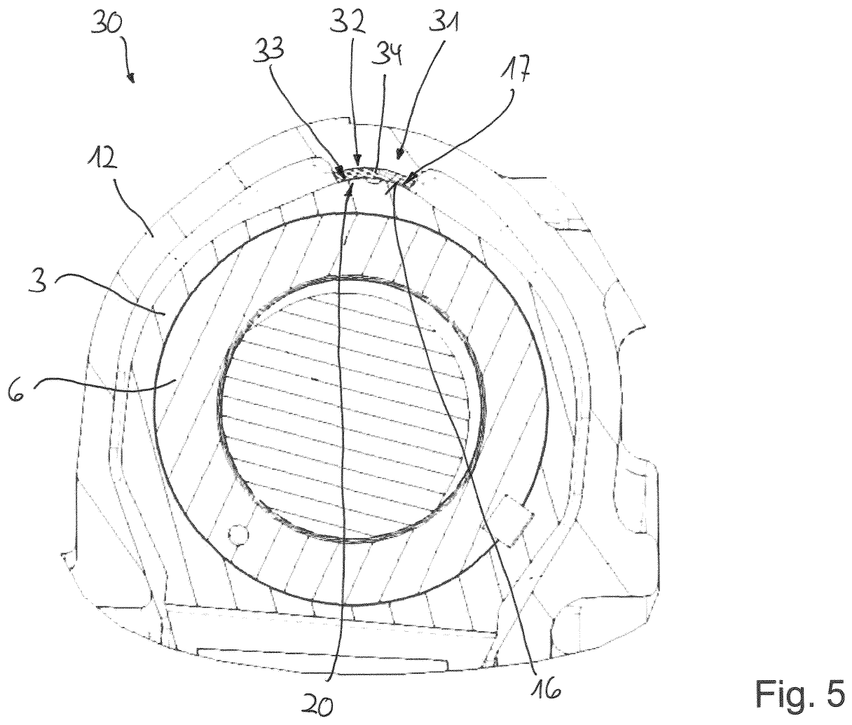

Finally, FIG. 5 shows a sectional view of a vehicle steering gear 30 having a spindle drive 31 according to an embodiment of the present disclosure. The vehicle steering gear 30 and the spindle drive 31 also correspond substantially to the variant according to FIGS. 1 and 2, with the sole difference that a plain bearing 32, via which the adjusting element 3 and the spindle nut 6 are axially guided relative to the housing 12, has, in addition to the bearing part 17, a further bearing part 33 in which the sliding surface 16 is formed by a bearing shell 34 which is fastened to the bearing part 33. The embodiment according to FIG. 5 otherwise corresponds to the variant according to FIGS. 1 and 2, so that reference is made to that described in this regard.

By means of the embodiments according to the present disclosure, in each case a spindle drive is provided in which a reliable function is implemented with a design which is as compact as possible.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS (PART OF THE DESCRIPTION)

1 Vehicle steering gear
2 Structural part
3 Adjusting element
4 Spindle drive
5 Spindle
6 Spindle nut
7 Axis of rotation
8 External thread
9 Internal thread
10 Receiving bore
11 Fixed structural part
12 Housing
13 Interior
14 Plain bearing
15 Sliding surface
16 Sliding surface
17 Bearing part
18 Bearing part
19 Elevation
20 Recess
21 Portion
22 Cutout
23 Vehicle steering gear
24 Spindle drive
25 Plain bearing
26 Elevation
27 Recess
28 Bearing part
29 Bearing part
30 Vehicle steering gear
31 Spindle drive
32 Plain bearing
33 Bearing part
34 Bearing shell

What is claimed is:

1. A spindle drive for a vehicle steering gear, comprising:
a spindle having an external thread; and
a spindle nut having an internal thread being guided on the external thread of the spindle,
wherein one of the spindle and the spindle nut is rotatable about an axis of rotation and produces, during rotation, by cooperation of the external thread and internal thread, a corresponding translational movement of the other of the spindle and the spindle nut,
wherein the other of the spindle and the spindle nut is axially displaceably guided via a plain bearing along the axis of rotation relative to a fixed structural part,
wherein the plain bearing is formed between sliding surfaces of a first and second bearing part, the first bearing part being provided on the other of the spindle and the spindle nut and the second bearing part being provided on the fixed structural part,
wherein, one of the first and second bearing parts is designed in cross section as an elevation which protrudes transversely to the axis of rotation into the other of the first and second bearing parts, the other of the first and second bearing parts being designed in cross section as a recess, and
wherein the recess surrounds the elevation on both sides in cross section in a rotational direction about the axis of rotation.

2. The spindle drive according to claim 1, wherein the elevation is designed in cross section with a convex rounded shape or V-shape.

3. The spindle drive according to claim 1, wherein the recess is designed in cross section with a concave rounded shape or V-shape.

4. The spindle drive according to claim 1, wherein the elevation and the recess are designed in cross section as counter-parts to one another.

5. The spindle drive according to claim 1, wherein the elevation is provided in a highest region in cross section and/or the recess is provided in a lowest region in cross section with one respective groove-like cutout.

6. The spindle drive according to claim 1, wherein the each of the sliding surfaces is configured on a coating which is applied to a respective bearing part of the first and second bearing parts, or on an element which is fastened to the respective bearing part.

7. The spindle drive according to claim 1, wherein the second bearing part is formed by a portion of an internal circumference of the fixed structural part, wherein the portion of the internal circumference protrudes into an interior which is defined by the fixed structural part and in which the spindle nut and the spindle are received.

8. The spindle drive according to claim 1, wherein the first bearing part is formed by a portion of an external circumference of a further structural part which is rigidly connected to the other of the spindle and the spindle nut.

9. The spindle drive according to claim 1, wherein the spindle is rotatable and produces, during rotation, by the cooperation of the external thread and internal thread, a corresponding translational movement of the spindle nut.

10. The spindle drive according to claim 1, wherein the first bearing part is designed as an elevation and the second bearing part is designed as a recess.

11. The spindle drive according to claim 1, wherein the fixed structural part is a housing.

12. A vehicle steering gear, comprising the spindle drive according to claim 1.
